(19) United States
(12) Patent Application Publication
(10) Pub. No.: US 2018/0160801 A1
(43) Pub. Date: Jun. 14, 2018

(54) Garment Rack

(71) Applicant: Whitmor, Inc., Southaven, MS (US)

(72) Inventor: Sandy Felsenthal, Memphis, TN (US)

(21) Appl. No.: 15/841,179

(22) Filed: Dec. 13, 2017

Related U.S. Application Data
(60) Provisional application No. 62/433,611, filed on Dec. 13, 2016.

(51) Int. Cl. A47B 61/00; A47B 47/00; F16B 7/00

(52) U.S. Cl. CPC A47B 61/00; F16B 7/00; A47B 47/00

(57) ABSTRACT

A garment rack comprising a bottom frame having a Z-shape; a first bottom vertical tube having a first end and a second end, the first end detachably connected to the bottom frame and the second end detachably connected to a first or female top frame; a second bottom vertical tube having a first end and a second end, the first end detachably connected to the bottom frame and the second end detachably connected to a second or male top frame; a first or female top frame detachably connected the first bottom vertical tube; and a second or male top frame detachably connected to the second bottom vertical tube; the male top frame detachably connected to the female top frame.

### BACKGROUND

The present disclosure relates to clothing storage, and garment racks in particular.

Garment racks are a popular item because they represent a relatively simple way to create additional space in a closet or other room. Traditional garment racks have a rectangular base with two long vertical posts extending therefrom, the vertical posts connected at their tops via a hanging bar upon which users may hang garments. Long vertical posts are advantageous because they allow users to hang longer garments such as dresses and pants, without the garments touching the floor. However, long vertical posts require a large packaging footprint and are cumbersome to transport.

A need exists for a garment rack that is easy to transport by having a compact packaging size. A need further exists for a garment rack that is simple for a user to assemble after purchase.

### BRIEF DESCRIPTION OF THE DRAWINGS

FIG. 1 is a perspective view of a garment rack in accordance with an embodiment of the present disclosure.

FIG. 2 is an exploded perspective view of a garment rack in accordance with an embodiment of the present disclosure.

FIG. 3A is a top perspective view of a bottom side frame in accordance with an embodiment of the present disclosure.

FIG. 3B is a bottom perspective view of a bottom side frame in accordance with an embodiment of the present disclosure.

FIG. 3C is a top plan view of a bottom side frame in accordance with an embodiment of the present disclosure.

FIG. 3D is a front elevation view of a bottom side frame in accordance with an embodiment of the present disclosure.

FIG. 3E is a side elevation view of a bottom side frame in accordance with an embodiment of the present disclosure.

FIG. 3F is a perspective view of a bottom side frame in accordance with an embodiment of the present disclosure.

FIG. 4A is a front perspective view of a female bottom diagonal frame in accordance with an embodiment of the present disclosure.

FIG. 4B is a rear perspective view of a female bottom diagonal frame in accordance with an embodiment of the present disclosure.

FIG. 4C is a side elevation view of a female bottom diagonal frame in accordance with an embodiment of the present disclosure.

FIG. 5A is a front perspective view of a male bottom diagonal frame in accordance with an embodiment of the present disclosure.

FIG. 5B is a rear perspective view of a male bottom diagonal frame in accordance with an embodiment of the present disclosure.

FIG. 5C is a side elevation view of a male bottom diagonal frame in accordance with an embodiment of the present disclosure.

FIG. 5D is an enlarged view of Area D of FIG. 5A.

FIG. 6 is a front perspective view and rear perspective view of a bottom side frame end cap in accordance with an embodiment of the present disclosure.

FIG. 7 is a front perspective view and rear perspective view of a wheel in accordance with an embodiment of the present disclosure.

FIG. 8A is a perspective view of a wheel and wheel bracket in accordance with an embodiment of the present disclosure.

FIG. 8B is a side elevation view of a wheel and wheel bracket in accordance with an embodiment of the present disclosure.

FIG. 8C is a front elevation view of a wheel and wheel bracket in accordance with an embodiment of the present disclosure.

FIG. 9A is a perspective view of a wheel and wheel bracket with a lock in accordance with an embodiment of the present disclosure.

FIG. 9B is a side elevation view of a wheel and wheel bracket with a lock in accordance with an embodiment of the present disclosure.

FIG. 9C is a front elevation view of a wheel and wheel bracket with a lock in accordance with an embodiment of the present disclosure.

FIG. 10A is an enlarged view of Area 10 of FIG. 1.

FIG. 10B is a perspective view of a hex-nut in accordance with an embodiment of the present disclosure.

FIG. 10C is a perspective view of a wheel spring washer in accordance with an embodiment of the present disclosure.

FIG. 11A is a perspective view of a bottom vertical tube in accordance with an embodiment of the present disclosure.

FIG. 11B is a perspective view of a bottom vertical tube in accordance with an embodiment of the present disclosure.

FIG. 11C is a side elevation view of a bottom vertical tube in accordance with an embodiment of the present disclosure.

FIG. 11D is a perspective view of a push-pin in accordance with an embodiment of the present disclosure.

FIG. 11E is a perspective view of a push-pin spring in accordance with an embodiment of the present disclosure.

FIG. 12 is a perspective view of an intermediate vertical tube in accordance with an embodiment of the present disclosure.

FIG. 13A is a top perspective view of a female top frame in accordance with an embodiment of the present disclosure.

FIG. 13B is a bottom perspective view of a female top frame in accordance with an embodiment of the present disclosure.

FIG. 13C is a side elevation view of a female top frame in accordance with an embodiment of the present disclosure.

FIG. 13D is a bottom plan view of a female top frame in accordance with an embodiment of the present disclosure.

FIG. 14A is a top perspective view of a male top frame in accordance with an embodiment of the present disclosure.

FIG. 14B is a bottom perspective view of a male top frame in accordance with an embodiment of the present disclosure.

FIG. 14C is a side elevation view of a male top frame in accordance with an embodiment of the present disclosure.

FIG. 14D is a bottom plan view of a male top frame in accordance with an embodiment of the present disclosure.

FIG. 15A is an exploded perspective view of a female top frame and a male top frame in accordance with an embodiment of the present disclosure.

FIG. 15B is a perspective view of a spring washer in accordance with an embodiment of the present disclosure.

FIG. 15C is a perspective view of a screw in accordance with an embodiment of the present disclosure.

FIG. 15D is a front perspective view and a rear perspective view of a vertical post end cap in accordance with an embodiment of the present disclosure.

FIG. 16 is a front elevation view of a garment rack in accordance with an embodiment of the present disclosure.

FIG. 17 is a side elevation view of a garment rack in accordance with an embodiment of the present disclosure.

FIG. 18 is a top plan view of a garment rack in accordance with an embodiment of the present disclosure.

### DETAILED DESCRIPTION

As described below, the present disclosure provides a garment rack.

In embodiments of the present invention A garment rack comprising a bottom frame having a Z-shape; a first bottom vertical tube having a first end and a second end, the first end detachably connected to the bottom frame and the second end detachably connected to a first or female top frame; a second bottom vertical tube having a first end and a second end, the first end detachably connected to the bottom frame and the second end detachably connected to a second or male top frame; a first or female top frame detachably connected the first bottom vertical tube; and a second or male top frame detachably connected to the second bottom vertical tube; the male top frame detachably connected to the female top frame.

In other embodiments of the present invention, the first bottom vertical tube is detachably connected to the bottom frame and the top frame by at least one intermediate vertical tube; and the second bottom vertical tube is detachably connected to the bottom frame and the top frame by the same amount of vertical tube(s).

In other embodiments, the first bottom vertical tube is detachably connected to the bottom frame and the top frame by a first intermediate vertical tube; and the second bottom vertical tube is detachably connected to the bottom frame and the top frame a second intermediate vertical tube.

The invention also comprises a kit for a garment rack. The kit may comprise a first bottom side frame comprising a bottom frame connector and a vertical tube connector; a second bottom side frame comprising a bottom frame connector and a vertical tube connector; a diagonal bottom frame comprising (i) a first end comprising a connector and (ii) a second end comprising joining connector the bottom side frames and diagonal bottom frame forming a Z-shape when engaged; a first vertical tube comprising (i) a first end comprising a connector sized to receive the connector of the first bottom side frame tube and (ii) a second end comprising a connector; a second vertical tube comprising (i) a first end comprising a connector sized to receive the second bottom side frame and (ii) a second end comprising a male connector; a first top frame comprising (i) a first end comprising a connector sized to receive a corresponding connector of the first vertical tube and (ii) a second end comprising a support insert; and a second top frame comprising (i) a first end comprising a connector sized to receive the second connector of the second vertical tube and (ii) a second end comprising a connector; wherein the second end connectors of the top frames are sized to join.

In other embodiments, the kit further comprises a first intermediate vertical tube sized to join the first bottom side frame and the first vertical tube; and a second intermediate vertical tube sized to join the second bottom side frame and the second vertical tube.

In other embodiments, the garment rack includes:

a bottom frame having a Z-shape;

a first bottom vertical tube having a first end and a second end, the first end detachably connected to the bottom frame and the second end detachably connected to a first end of a first intermediate vertical tube;

a second bottom vertical tube having a first end and a second end, the first end detachably connected to the bottom frame and the second end detachably connected to a first end of a second intermediate vertical tube;

a female top frame detachably connected to a second end of the first intermediate vertical tube;

a male top frame detachably connected to a second end of the second intermediate vertical tube; the male top frame detachably connected to the female top frame.

### A. Bottom Frame

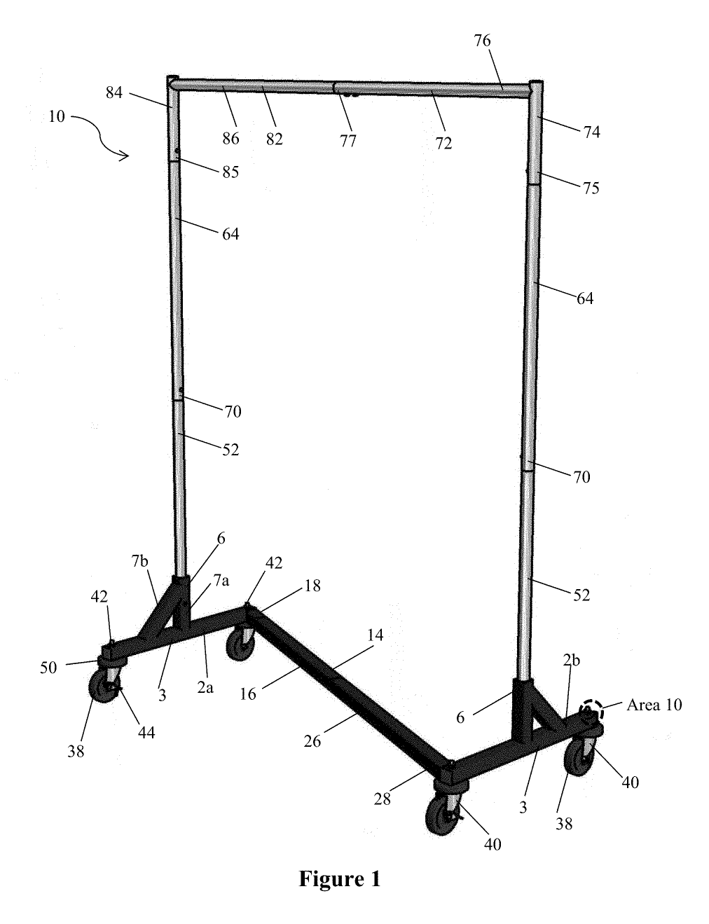

Referring to FIG. 1, a garment rack 1 is provided. The garment rack 10 includes a bottom frame 14. The bottom frame 14 has a “Z-shape,” as shown in FIG. 1 and FIG. 18. A bottom frame 14 with a “Z-shape” has two side frames connected via a diagonal frame.

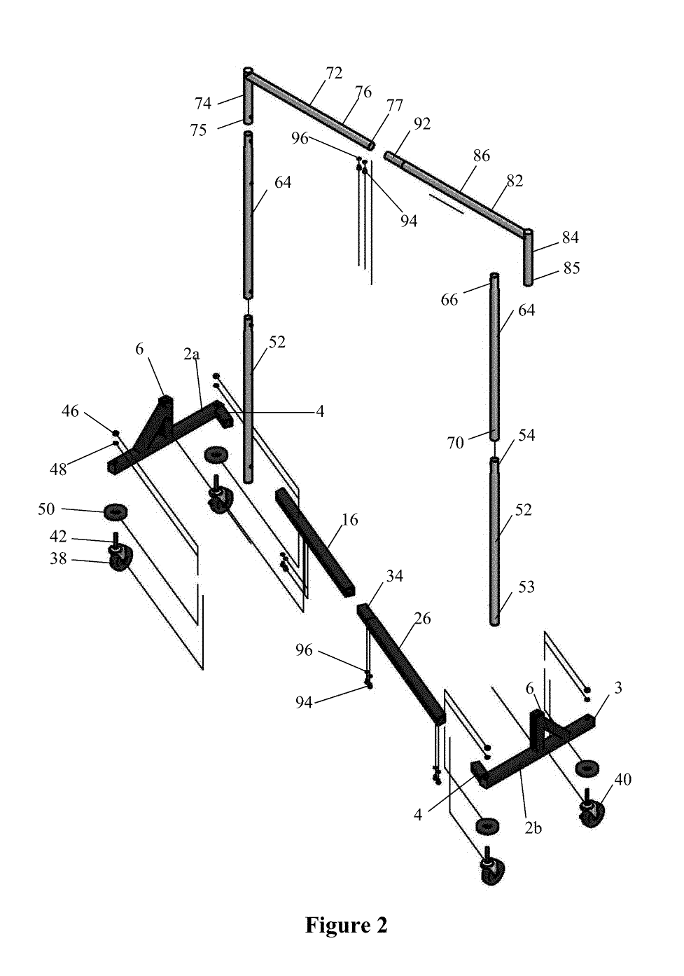

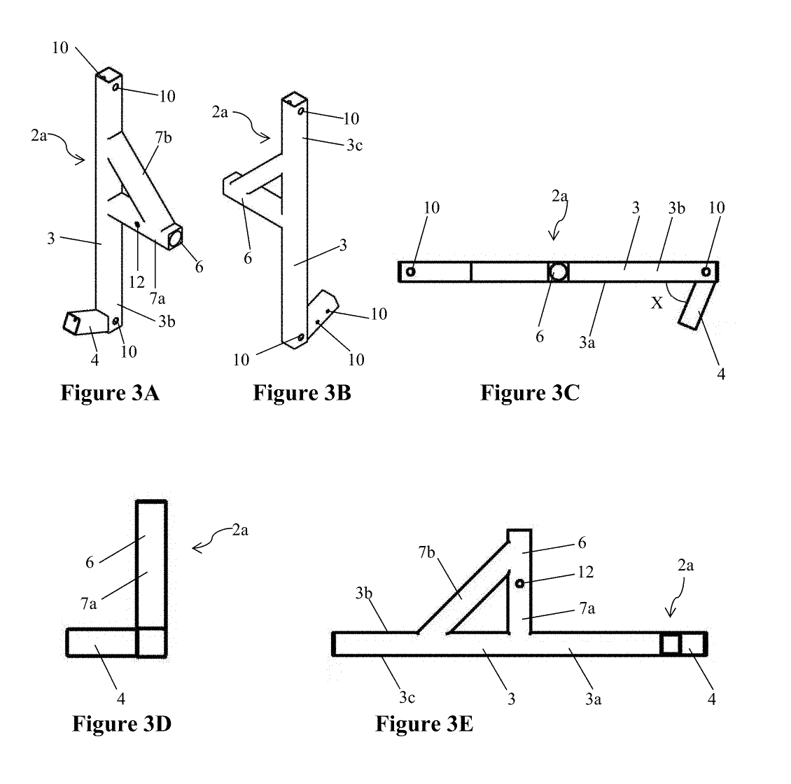

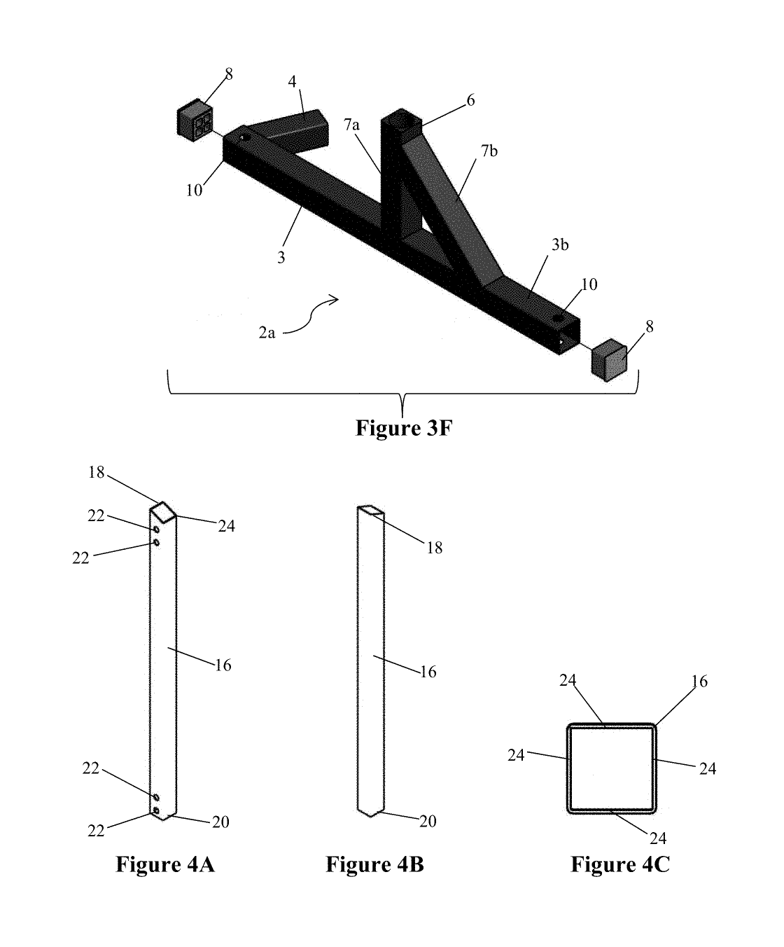

In an embodiment, the bottom frame 14 comprises two bottom side frames 2a, 2b. Each bottom side frame 2a comprises a support frame 3, a connector 4, such as a male connector, and a vertical tube connector 6, as shown in FIGS. 3A-3F, which depict bottom side frame 2a. Bottom side frame 2b is a mirror-image of bottom side frame 2a, as shown in FIG. 2. Thus, the following description of bottom side frame 2a also describes bottom side frame 2b.

As shown in FIGS. 1 and 3F, the bottom side frame 2a includes a support frame 3. When the garment rack 10 is placed on the ground, the support frame 3 extends generally parallel to the ground. The support frame 3 has two ends.

In an embodiment, a threaded opening 10 extends through the top side 3b and the bottom side 3c of the support frame 3 at each end of the support frame 3, as shown in FIGS. 3A, 3B and 3F. The threaded opening 10 through the top side 3b and the bottom side 3c of the support frame 3 are aligned.

At one end of the support frame 3 is a connector 4, such as a male connector. This connector 4 extends from an interior side 3a of the support frame 3 at an angle, X, as shown in FIG. 3C. When the garment rack 10 is placed on the ground, this connector extends generally parallel to the ground and at an angle, X, to the interior side 3a of the support frame 3. In an embodiment, the angle, X, is less than 90°, or from greater than 0° to less than 90°, or from 20°, or 30°, or 40°, or 45°, or 50°, or 55°, or 60° to 65°, or 70°, or 75°, or 80°, or 85°. In another embodiment, the angle, X, is from 60°, or 61°, or 62°, or 63°, or 64°, or 65°, or 66°, or 67° to 68°, or 69°, or 70°, or 71°, or 72°, or 73°, or 74°, or 75°. In another embodiment, the angle, X, is 67.4°. In another embodiment, the angle is from about 20° to about 170°.

In an embodiment, the male connector 4 includes a threaded opening 10. In an embodiment, the male connector 4 includes a plurality of threaded openings 10, or at least two threaded openings 10, or from 1 to 2, or 3, or 4 threaded openings 10.

The bottom side frame 2a also includes a vertical tube connector 6. The vertical tube connector 6 extends perpendicular, or at about a 90° angle, to the support frame 3. The vertical tube connector 6 may be a single post 7a, a post 7a with one angled support beam 7b, or a post 7a with two angled support beams 7b. FIGS. 1 and 3A-3F depict a bottom side frame 2a with a vertical tube connector 6 having a post 7a and one angled support beam 7b. In an embodiment, the post 7a includes a push-pin opening 12. FIGS. 3A and 3E depict a bottom side frame 2a with a vertical tube connector 6 having a post 7a with a push-pin opening 12.

The male connector 4, the support frame 3, and the vertical tube connector 6 may have an integral design or a composite design. An “integral design” is formed from one piece of rigid material, such as a molded piece. A “composite design” is formed from more than one distinct piece (or part), which upon assembly are combined to form the bottom side frame 2a.

The bottom side frame 2a, 2b is formed from a rigid material. A nonlimiting example of a suitable material is a metal such as steel. The bottom side frame 2a, 2b may or may not be coated. Nonlimiting examples of suitable coatings include paint and polymeric coatings. In an embodiment, the bottom side frame 2a, 2b is formed from a coated steel.

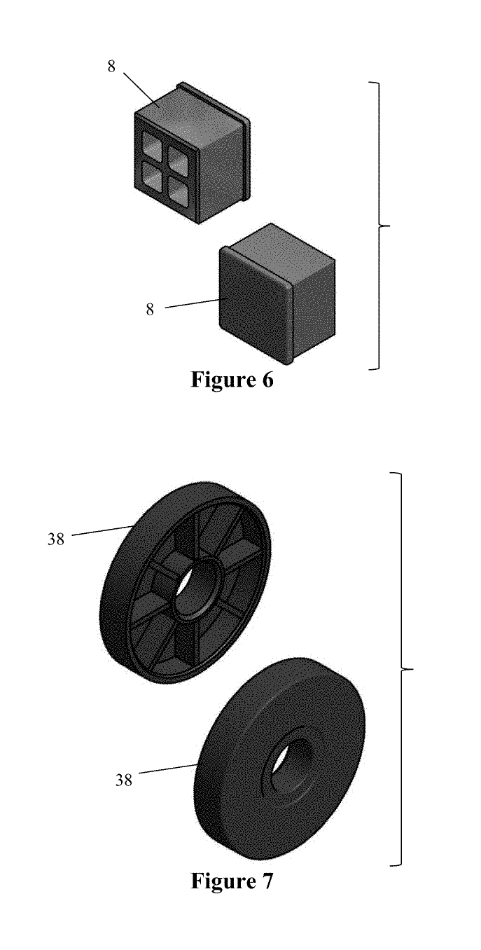

In an embodiment, each end of the support frame 3 includes an end cap 8, as shown in FIGS. 3F and 6. The end cap 8 is sized to fit within a portion of the support frame 3. End caps 8 are advantageous because they cover sharp edges, making the garment rack 10 safer for a consumer to use. The end cap 8 is formed from a rigid material. A nonlimiting example of a suitable rigid material is a polymeric material. FIG. 6 depicts a front perspective view and a rear perspective view of a nonlimiting example of a bottom side frame end cap 8 formed from a polymeric material.

The bottom frame 14 comprises a diagonal frame. The diagonal frame comprises a first or female bottom diagonal frame 16 and a second or male bottom diagonal frame 26.

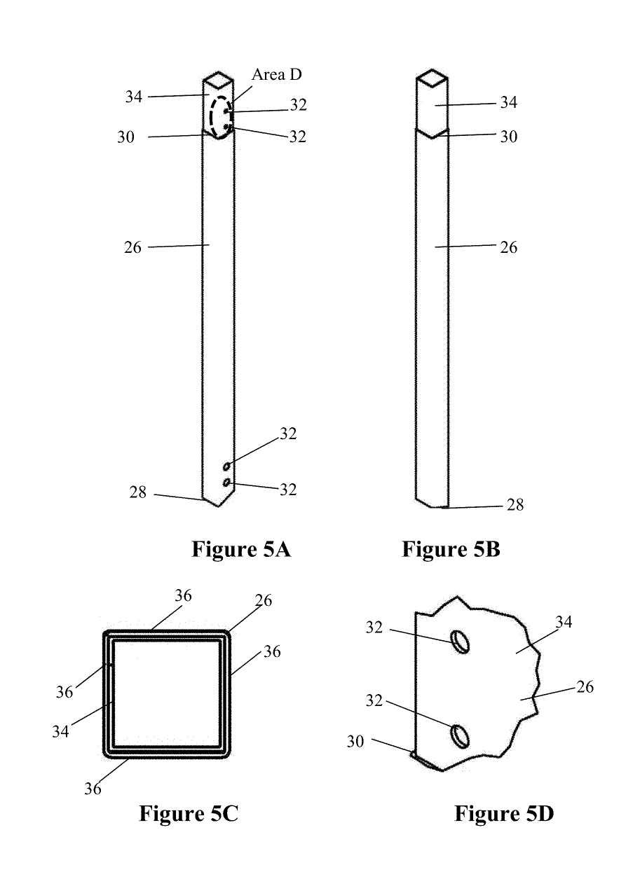

FIGS. 5A-5D depict a male bottom diagonal frame 26. The male bottom diagonal frame 26 includes an angled end 28 and a straight end 30. The angled end 28 of the male bottom diagonal frame 26 includes a female connector sized to receive the bottom side frame male connector 4. The angled end 28 has the same angle, X, at which the male connector 4 extends relative to the interior side 3a of the support frame 3. Thus, when the male connector 4 of the bottom side frame 2a, 2b is positioned within the female connector at the angled end 28 of the male bottom diagonal frame 26, the angled end 28 abuts the support frame 3, as shown in FIG. 18.

The straight end 30 of the male bottom diagonal frame 26 includes a support insert 34, as shown in FIGS. 5A and 5B. The support insert 34 and the male bottom diagonal frame 26 have a composite design. The support insert 34 is sized to fit within a portion of the straight end 30 of the male bottom diagonal frame 26. The support insert 34 is a male connector. In an embodiment, the portion of the support insert 34 that is located within the male bottom diagonal frame 26 is equal to the portion of the support insert 34 that extends from the straight end 30 of the male bottom diagonal frame 26. In an embodiment, the support insert 34 fits tightly within the male bottom diagonal frame 26 to prevent instability. In an embodiment, the support insert 34 includes a plurality of threaded openings 32, or at least two threaded openings 32, or from 1 to 2, or 3, or 4, or 5, or 6 threaded openings 32. FIGS. 5A and 5D depict a support insert 34 with 2 threaded openings 32.

In an embodiment, the male bottom diagonal frame 26 includes a plurality of threaded openings 32, or at least two threaded openings 32, or from 1 to 2, or 3, or 4, or 5, or 6 threaded openings 32. The threaded openings 32 extend through a wall 36 of the male bottom diagonal frame 26. In an embodiment, each threaded opening 32 extends through one wall 36 of the male bottom diagonal frame 26. In an embodiment, two threaded openings 32 extend through a wall 36 of the male bottom diagonal frame 26 at the angled end 28, as shown in FIG. 5A. In an embodiment, when the male connector 4 of the bottom side frame 2a, 2b is positioned within the female connector at the angled end 28 of the male bottom diagonal frame 26, the threaded openings 10 in the male connector 4 align with the threaded openings 32 at the angled end 28 of the male bottom diagonal frame 26, such that a threaded connector, such as a screw 94, may extend through the threaded openings 10 in the male connector 4 and the threaded openings at the angled end 28 of the male bottom diagonal frame 26 to fasten the male connector 4 to the male bottom diagonal frame 26, as shown in FIG. 2. In an embodiment, the male connector 4 is detachably connected to the male bottom diagonal frame 26 with a screw 94 and a spring washer 96.

FIGS. 4A-4C depict a female bottom diagonal frame 16. The female bottom diagonal frame 16 includes an angled end 18 and a straight end 20. The angled end 18 of the female bottom diagonal frame 16 includes a female connector sized to receive the bottom side frame male connector 4. The angled end 18 has the same angle, X, at which the male connector 4 extends relative to the interior side 3a of the support frame 3. Thus, when the male connector 4 of the bottom side frame 2a, 2b is positioned within the female connector at the angled end 18 of the female bottom diagonal frame 16, the angled end 18 abuts the support frame 3, as shown in FIG. 18.

The straight end 20 of the female bottom diagonal frame 16 includes a female connector sized to receive the support insert 34 in the male bottom diagonal frame 26. In an embodiment, when the female bottom diagonal frame 16 and the male bottom diagonal frame 26 are fit together, the portion of the support insert 34 located within the female bottom diagonal frame 16 is equal to the portion of the support insert 34 located within the male bottom diagonal frame 16. In an embodiment, when the female bottom diagonal frame 16 and the male bottom diagonal frame 26 are fit together, the support insert 34 is not visible.

In an embodiment, the female bottom diagonal frame 16 includes a plurality of threaded openings 22, or at least two threaded openings 22, or from 1 to 2, or 3, or 4, or 5, or 6 threaded openings 22. The threaded openings 22 extend through a wall 24 of the female bottom diagonal frame 18. In an embodiment, each threaded opening 22 extends through one wall 24 of the female bottom diagonal frame 18. In an embodiment, two threaded openings 22 extend through a wall 24 of the female bottom diagonal frame 16 at the angled end 18, and two threaded openings 22 extend through the same wall 24 of the female bottom diagonal frame 16 at the straight end 20, as shown in FIG. 4A.

In an embodiment, when the male connector 4 of the bottom side frame 2a, 2b is positioned within the female connector at the angled end 18 of the female bottom diagonal frame 16, the threaded openings 10 in the male connector 4 align with the threaded openings 22 at the angled end 18 of the female bottom diagonal frame 16, such that a threaded connector, such as a screw 94, may extend through the threaded openings 10 in the male connector 4 and the threaded openings 22 at the angled end 18 of the female bottom diagonal frame 16 to fasten the male connector 4 to the female bottom diagonal frame 16, as shown in FIG. 2. In an embodiment, the male connector 4 is detachably connected to the female bottom diagonal frame 16 with a screw 94 and a spring washer 96.

In an embodiment, when the support insert 34 of the male bottom diagonal frame 26 is positioned within the female connector at the straight end 20 of the female bottom diagonal frame 16, the threaded openings 32 in the support insert 34 align with the threaded openings 22 at the straight end 20 of the female bottom diagonal frame 16, such that a threaded connector, such as a screw 94, may extend through the threaded openings 32 in the support insert 34 and the threaded openings at the straight end 20 of the female bottom diagonal frame 16 to fasten the support insert 34 (and further, the male bottom diagonal frame 26) to the female bottom diagonal frame 16, as shown in FIG. 2. In an embodiment, the support insert 34 (and further, the male bottom diagonal frame 26) is detachably connected to the female bottom diagonal frame 16 with a screw 94 and a spring washer 96.

The female bottom diagonal frame 16 and the male bottom diagonal frame 26 each is formed from a rigid material. A nonlimiting example of a suitable material is a metal such as steel. The female bottom diagonal frame 16 and the male bottom diagonal frame 26 may or may not be coated. Nonlimiting examples of suitable coatings include paint and polymeric coatings. In an embodiment, the female bottom diagonal frame 16 and the male bottom diagonal frame 26 each is formed from a coated steel. The female bottom diagonal frame 16, the male bottom diagonal frame 26, and the bottom side frames 2a, 2b may or may not be formed from the same type of rigid material. In an embodiment, female bottom diagonal frame 16, the male bottom diagonal frame 26, and the bottom side frames 2a, 2b are formed from the same type of rigid material.

In an embodiment, the bottom side frame 2a is detachably connected to the female bottom diagonal frame 16, the female bottom diagonal frame 16 is detachably connected to the male bottom diagonal frame 26, and the male bottom diagonal frame 26 is detachably connected to the bottom side frame 2b to form a bottom frame having a “Z-shape” 14, as shown in FIG. 1. In an alternate embodiment, the bottom side frame 2a is detachably connected to the male bottom diagonal frame 26, the male bottom diagonal frame 26 is detachably connected to the female bottom diagonal frame 16, and the female bottom diagonal frame 16 is detachably connected to the bottom side frame 2b to form a bottom frame having a “Z-shape” 14.

### B. Optional Wheels

In an embodiment, the garment rack 10 includes a plurality of wheels 38, as shown in FIG. 1. In an embodiment, the garment rack 10 includes from 2, or 3, or 4 to 5, or 6, or 7, or 8, or 9, or 10 wheels 38. In another embodiment, the garment rack 10 includes four wheels 38. The wheels 38 are formed from a rigid material. A nonlimiting example of a suitable rigid material is a polymeric material. FIG. 7 depicts a front perspective view and rear perspective view of a nonlimiting example of a wheel 38 formed from a polymeric material.

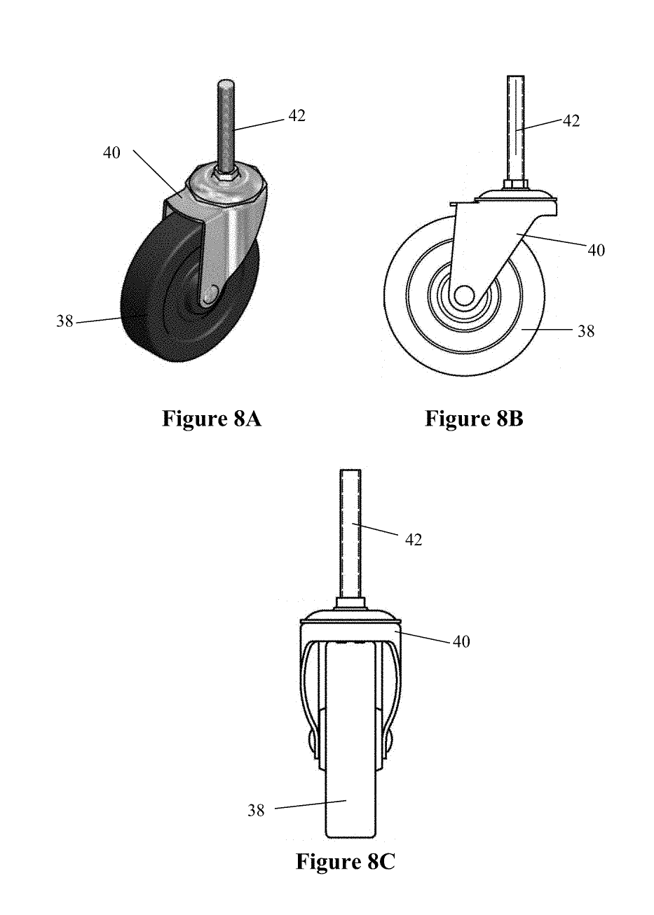

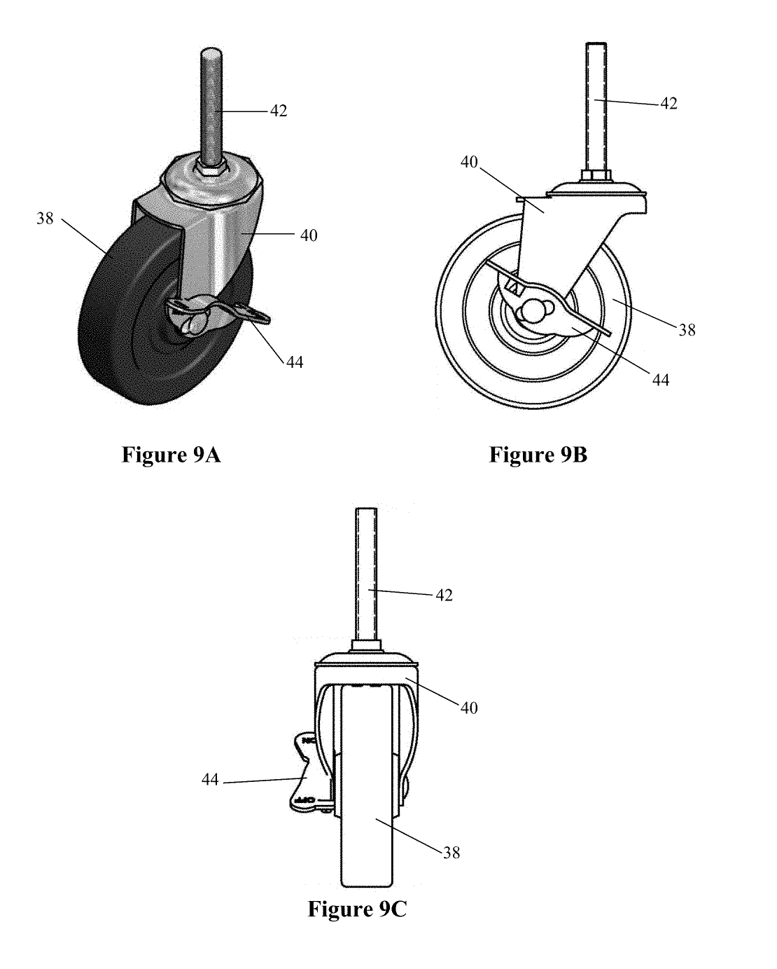

Each wheel 38 is detachably connected to a wheel bracket 40 having a threaded post 42, as shown in FIGS. 8A-9C. The wheel bracket 40 may or may not have a lock 44. FIGS. 8A-8C depict a wheel 38 and a wheel bracket 40 without a lock. FIGS. 9A-9C depict a wheel 38 and a wheel bracket 40 with a lock 44. The lock 44 has an “ON” position and an “OFF” position, as shown in FIG. 9C. When placed in the “ON” position, the lock 44 prevents the wheel 38 from spinning, thus preventing the garment rack 10 from moving. When placed in the “OFF” position, the wheel 38 can freely spin, thus allowing the garment rack 10 to move. The lock 44 depicted in FIGS. 9A-9C is in the “OFF” position.

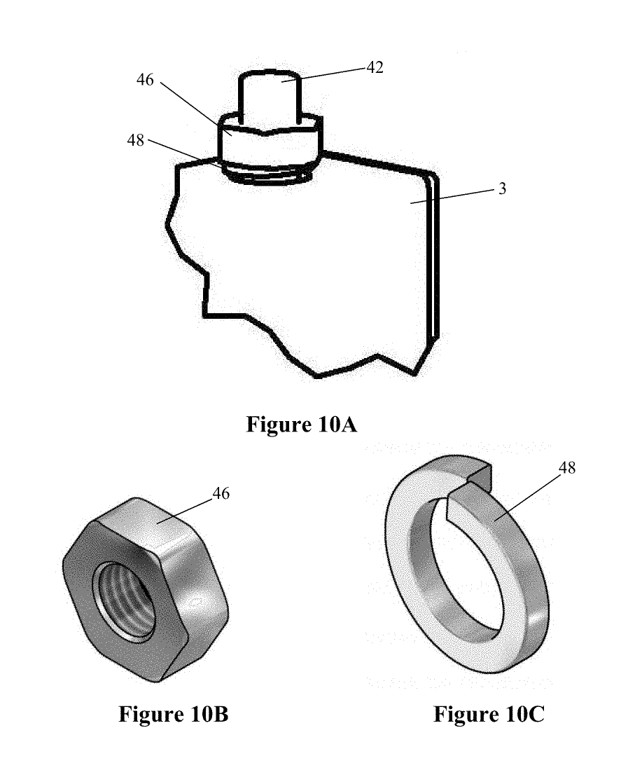

The threaded post 42 is sized to fit within the threaded openings 10 extending through the top side 3b and the bottom side 3c of the support frame 3 at each end of the support frame 3. The threaded post 42 extends through the threaded opening 10 in the bottom side 3c of the support frame 3, and through the threaded opening 10 in the top side 3b of the support frame 3, as shown in FIG. 1. The wheel bracket 40 is detachably connected to the support frame 3, and thus the bottom side frame 2a, 2b, by threading a hex-nut 46 onto the threaded post 42 extending through the support frame 3. In an embodiment, a wheel spring washer 48 is positioned on the threaded post 42 before the hex-nut 46 is threaded onto the threaded post 42, as shown in FIG. 10A. FIG. 10A depicts a threaded post 42 extending through a support frame 3, with a wheel spring washer 48 positioned on the threaded post 42 and a hex-nut 46 threaded onto the threaded post 42. FIG. 10B depicts a nonlimiting example of a hex-nut 46. FIG. 10C depicts a nonlimiting example of a wheel spring washer 48.

The wheel bracket 40, and further the wheel 38, can advantageously rotate 360° around an axis formed by the threaded post 42, allowing the garment rack 10 to be easily maneuverable.

In a further embodiment, a wheel bumper 50 is located on the threaded post 42 between the wheel 38 and the support frame 3, as shown in FIGS. 1-2.

In an embodiment, a plurality of wheels 38 are detachably connected to each bottom side frame 2a, 2b. In an embodiment, two wheels 38 are detachably connected to each bottom side frame 2a, 2b, as shown in FIG. 1. In an embodiment, the garment rack 10 includes at least one wheel bracket 40 with a lock 44. FIG. 1 depicts a garment rack 10 with four wheels 38, two of which include locks 44.

### C. Bottom Vertical Tubes

The garment rack 10 includes a plurality of bottom vertical tubes 52, as shown in FIGS. 1 and 2. In an embodiment, the garment rack 10 includes two bottom vertical tubes 52.

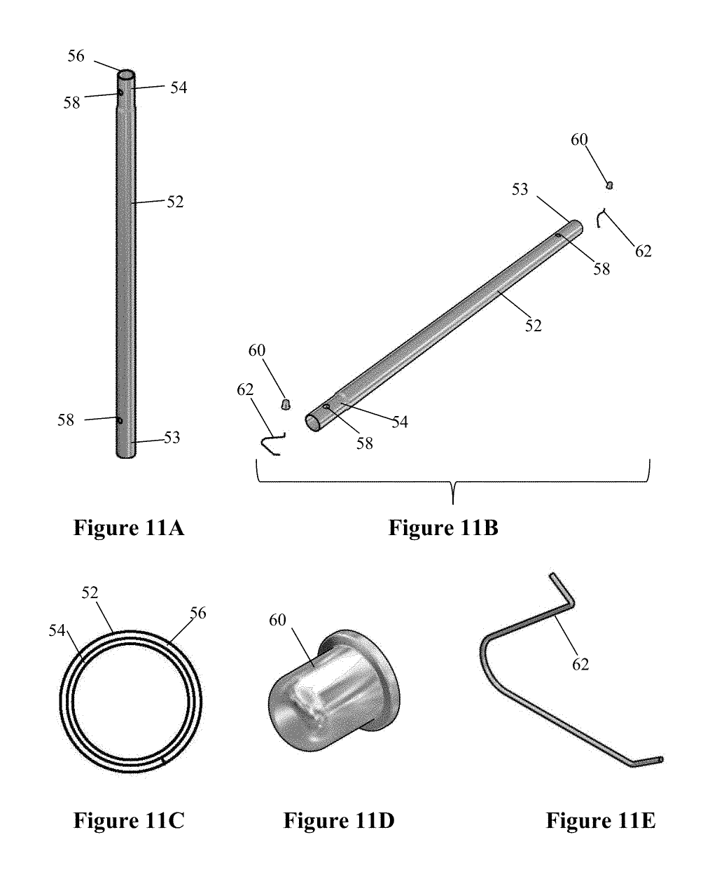

Each bottom vertical tube 52 has two ends, as shown in FIGS. 11A-11B. A first end 53 of the bottom vertical tube 52 is sized to fit within the vertical tube connector 6 of the bottom side frame 2a, 2b. The second end of the bottom vertical tube 52 is a male connector 54, as shown in FIGS. 11A-11C.

In an embodiment, each bottom vertical tube 52 includes a plurality of push-pin openings 58 that extend through a wall 56 of the bottom vertical tube 52. FIGS. 11A and 11B depict a bottom vertical tube 52 with two push-pin openings 58. In an embodiment, the bottom vertical tube 52 includes a push pin opening 58 in the male connector 54 and a push-pin opening 58 at the first end 53. In an embodiment, when the bottom vertical tube 52 is positioned in the vertical tube connector 6 of the bottom side frame 2a, 2b, the push-pin opening 58 at the first end 53 of the bottom vertical tube 52 aligns with the push-pin opening 12 in the vertical tube connector 6.

In an embodiment, each bottom vertical tube 52 includes a plurality of push-pin connectors. Each push-pin connector includes a push-pin 60 and a push-pin spring 62, as shown in FIG. 11B. FIG. 11D depicts a nonlimiting example of a push-pin 60. FIG. 11E depicts a nonlimiting example of a push-pin spring 62. In an embodiment, the push-pin spring 62 and the push-pin 60 are located within the bottom vertical tube 52, such that the push-pin 60 is aligned with and extends through a push-pin opening 58. The push-pin spring 62 exerts a force on the push-pin 60 such that the push-pin 60 remains extended through the push-pin opening 58 unless a user presses (i.e., pushes) the push-pin 60 and exerts a pressure sufficient to collapse the push-pin spring 62. Once the user releases the push-pin 60, the push-pin spring 62 forces the push-pin 60 back through the push-pin opening 58. Push-pin connectors are advantageous because they are detachable connections that do not require the use of a tool to detach the components.

In an embodiment, each bottom vertical tube 52 is detachably connected to a bottom side frame 2a, 2b via a push-pin connector. In an embodiment, when the bottom vertical tube 52 is positioned in the vertical tube connector 6 of the bottom side frame 2a, 2b, the push-pin opening 58 at the first end 53 of the bottom vertical tube 52 aligns with the push-pin opening 12 in the vertical tube connector 6, and the push-pin 60 extends through the push-pin opening 58 at the first end 53 of the bottom vertical tube 52 and the push-pin opening 12 in the vertical tube connector 6.

### D. Intermediate Vertical Tubes

The garment rack 10 includes a plurality of intermediate vertical tubes 64, as shown in FIGS. 1 and 2. In an embodiment, the garment rack 10 includes two intermediate vertical tubes 64.

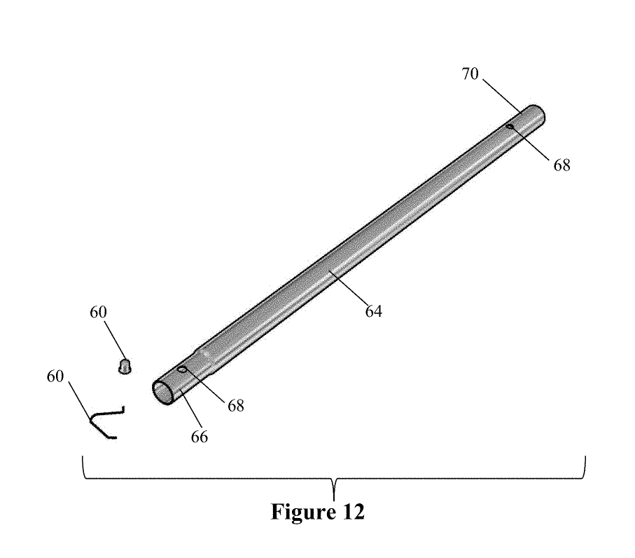

Each intermediate vertical tube 64 has two ends, as shown in FIG. 12. A first end of the intermediate vertical tube 64 is a female connector 70. A second end of the intermediate vertical tube 64 is a male connector 66. The female connector 70 is sized to receive the male connector 54 of the bottom vertical tube 52.

In an embodiment, each intermediate vertical tube 64 includes a plurality of push-pin openings 68 that extend through a wall of the intermediate vertical tube 64. FIG. 12 depicts an intermediate vertical tube 64 with two push-pin openings 68. In an embodiment, the intermediate vertical tube 64 includes a push pin opening 68 in the male connector 66 and a push-pin opening 68 at the female connector 70. In an embodiment, when the male connector 54 of the bottom vertical tube 52 is positioned within the female connector 70 of the intermediate vertical tube 64, the push-pin opening 58 at the male connector 54 of the bottom vertical tube 52 aligns with the push-pin opening 68 at the female connector 70 of the intermediate vertical tube 64.

In an embodiment, each intermediate vertical tube 64 includes a push-pin connector. Each push-pin connector includes a push-pin 60 and a push-pin spring 62, as shown in FIG. 12. In an embodiment, the push-pin spring 62 and the push-pin 60 are located within the intermediate vertical tube 64 at the push-pin opening 68 located at the male connector 66, such that the push-pin 60 is aligned with and extends through the push-pin opening 68 located at the male connector 66. The push-pin spring 62 exerts a force on the push-pin 60 such that the push-pin 60 remains extended through the push-pin opening 68 unless a user presses (i.e., pushes) the push-pin 60 and exerts a pressure sufficient to collapse the push-pin spring 62. Once the user releases the push-pin 60, the push-pin spring 62 forces the push-pin 60 back through the push-pin opening 68.

In an embodiment, each bottom vertical tube 52 is detachably connected to an intermediate vertical tube 64 via a push-pin connector. In an embodiment, when the male connector 54 of the bottom vertical tube 52 is positioned within the female connector 70 of the intermediate vertical tube 64, the push-pin opening 58 at the male connector 54 of the bottom vertical tube 52 aligns with the push-pin opening 68 at the female connector 70 of the intermediate vertical tube 64, and the push-pin 60 extends through the push-pin opening 68 at the female connector 70 of the intermediate vertical tube 64 and the push-pin opening 58 at the male connector 54 of the bottom vertical tube 52.

### E. Top Frame

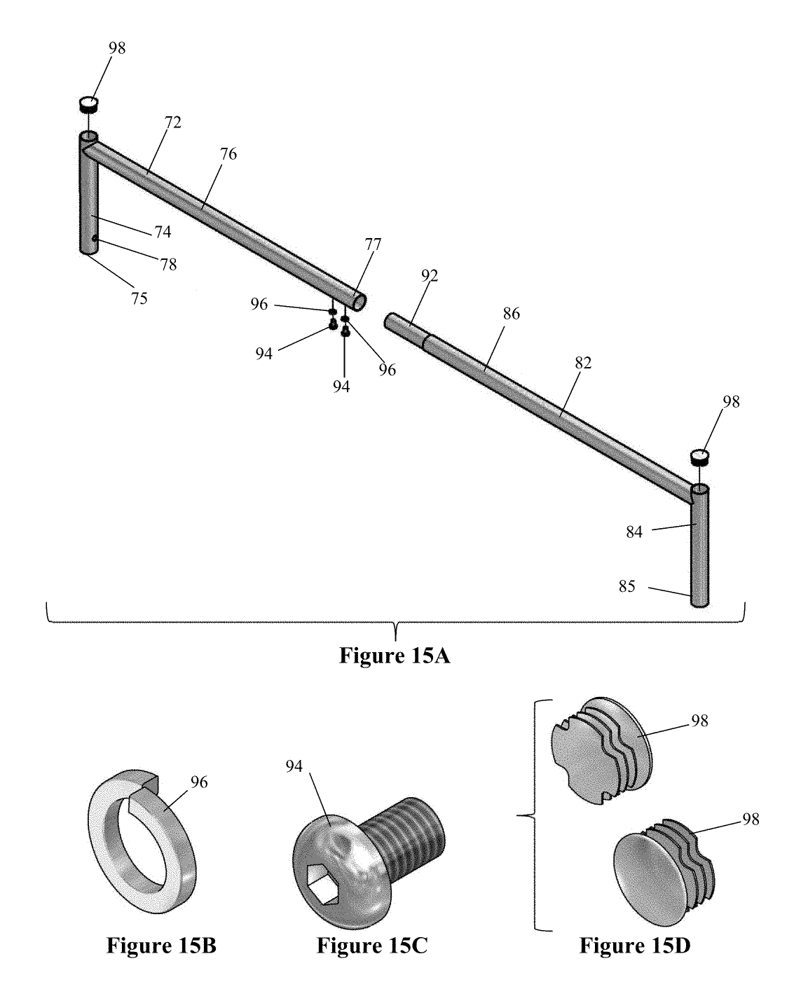

The garment rack 10 includes a top frame including a male top frame 82 and a female top frame 72, as shown in FIGS. 1 and 15A.

i. Male Top Frame

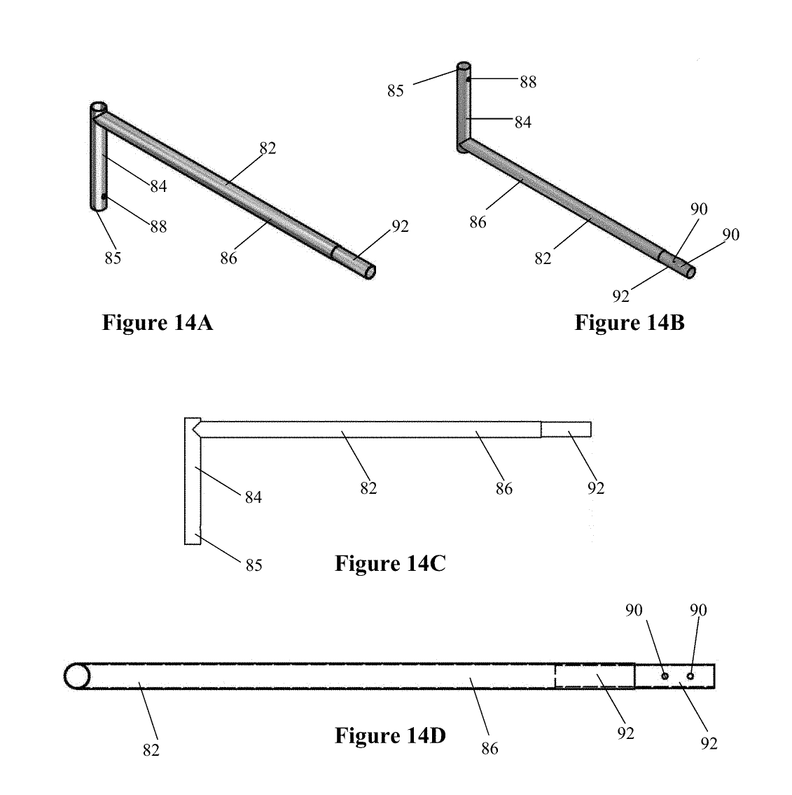

The male top frame 82 includes a vertical tube 84 with a first end that is a female connector 85 and a horizontal tube 86 at the second end of the vertical tube 84, as shown in FIGS. 14A-14D. The terms “vertical” and “horizontal,” as used with respect to the top frame, refer to the alignment of a tube when the garment rack 10 is assembled. The vertical tube 84 and the horizontal tube 86 extend perpendicular to one another, or at a 90° angle to one another, as shown in FIG. 14C.

The female connector 85 of the male top frame 82 is sized to receive the male connector 66 of the intermediate vertical tube 64. In an embodiment, the vertical tube 84 includes a push-pin opening 88, or a plurality of push-pin openings 88, at the female connector 85, as shown in FIGS. 14A and 14B.

In an embodiment, each male top frame 82 is detachably connected to an intermediate vertical tube 64 via a push-pin connector. In an embodiment, when the male connector 66 of the intermediate vertical tube 64 is positioned within the female connector 85 of the vertical tube 84 of the male top frame 82, the push-pin opening 68 at the male connector 66 of the intermediate vertical tube 64 aligns with the push-pin opening 88 at the female connector 85 of the vertical tube 84 of the male top frame 82, and the push-pin 60 extends through the push-pin opening 68 at the male connector 66 of the intermediate vertical tube 64 and the push-pin 88 at the female connector 85 of the vertical tube 84 of the male top frame 82.

The horizontal tube 86 includes two ends. The vertical tube 84 is located at the first end of the horizontal tube 86. The vertical tube 84 and the horizontal tube 86 have an integral design. A support insert 92 is located at the second end of the horizontal tube 86.

The support insert 92 and the horizontal tube 86 have a composite design. The support insert 92 is sized to fit within a portion of the horizontal tube 86, as shown in FIG. 14D. The support insert 92 is a male connector. In an embodiment, the portion of the support insert 92 located within the male top frame's horizontal tube 86 is equal to the portion of the support insert 92 that extends from the male top frame's horizontal tube 86. In an embodiment, the support insert 92 fits tightly within the male top frame's horizontal tube 86 to prevent instability. In an embodiment, the support insert 92 includes a plurality of threaded openings 90, or at least two threaded openings 90, or from 1 to 2, or 3, or 4, or 5, or 6 threaded openings 90. FIG. 14D depicts a support insert 92 with two threaded openings 90.

ii. Female Top Frame

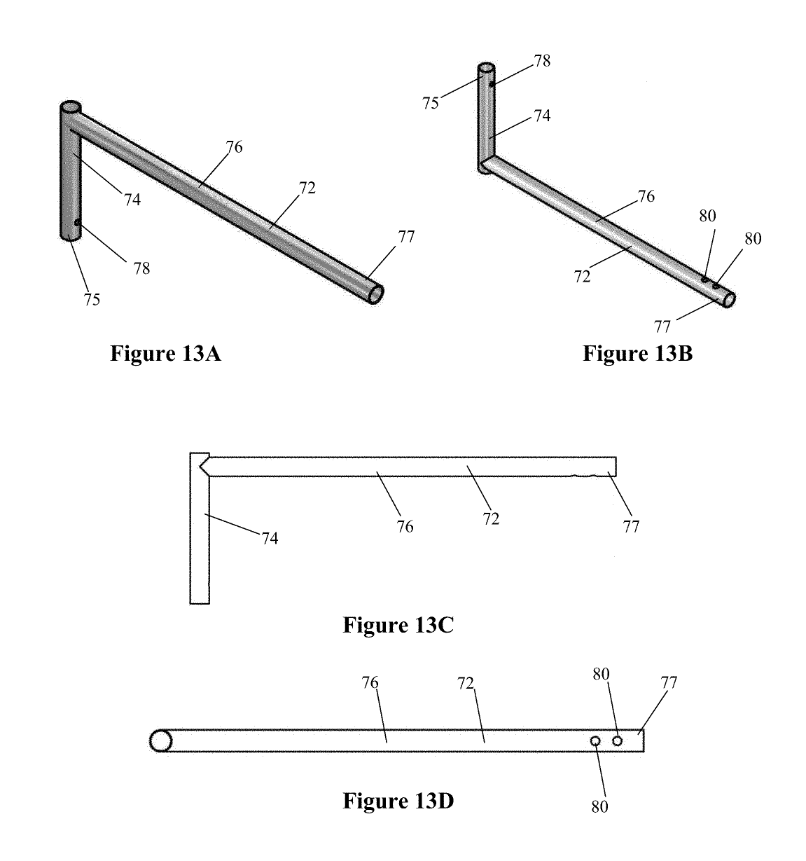

The female top frame 72 includes a vertical tube 74 with a first end that is a female connector 75 and a horizontal tube 76 at the second end of the vertical tube 74, as shown in FIGS. 13A-13D. The vertical tube 74 and the horizontal tube 76 extend perpendicular to one another, or at a 90° angle to one another, as shown in FIG. 13C.

The female connector 75 of the vertical tube 74 of the female top frame 72 is sized to receive the male connector 66 of the intermediate vertical tube 64. In an embodiment, the vertical tube 74 includes a push-pin opening 78, or a plurality of push-pin openings 78, at the female connector 75 of the vertical tube 74, as shown in FIGS. 13A and 13B.

In an embodiment, each female top frame 72 is detachably connected to an intermediate vertical tube 64 via a push-pin connector. In an embodiment, when the male connector 66 of the intermediate vertical tube 64 is positioned within the female connector 75 of the vertical tube 74 of the female top frame 72, the push-pin opening 68 at the male connector 66 of the intermediate vertical tube 64 aligns with the push-pin opening 78 at the female connector 75 of the vertical tube 74 of the female top frame 72, and the push-pin 60 extends through the push-pin opening 68 at the male connector 66 of the intermediate vertical tube 64 and the push-pin 78 at the female connector 75 of the vertical tube 74 of the female top frame 72.

The horizontal tube 76 includes two ends. The vertical tube 74 is located at the first end of the horizontal tube 76. The vertical tube 74 and the horizontal tube 76 have an integral design. A horizontal female connector 77 is located at the second end of the horizontal tube 76.

The horizontal female connector 77 is sized to receive the support insert 92 of the male top frame 82, as shown in FIG. 15A. In an embodiment, when the horizontal female connector 77 and the male top frame 82 are fit together, the portion of the support insert 92 located within the female top frame 72 is equal to the portion of the support insert 92 located within the male top frame 82. In an embodiment, when the female top frame 72 and the male top frame 82 are fit together, the support insert 92 is not visible.

In an embodiment, the horizontal tube 76 includes a plurality of threaded openings 80 at the horizontal female connector 77, as shown in FIGS. 13B and 13D. In an embodiment, the horizontal tube 76 includes from 2, or 3 to 4 threaded openings 80 at the horizontal female connector 77. FIG. 13D depicts a female top frame 72 having a horizontal tube 76 with two threaded openings 80 at the horizontal female connector 77. In an embodiment, when the support insert 92 of the male top frame 82 is positioned within the female horizontal connector 77 of the female top frame 72, the threaded openings 90 in the support insert 92 align with the threaded openings 80 at the horizontal female connector 77, such that a threaded connector, such as a screw 94, may extend through the threaded openings 80 at the horizontal female connector 77 and the threaded openings 90 in the support insert 92 to fasten the support insert 92 (and further, the male top frame 82) to the female top frame 72, as shown in FIGS. 2 and 15A. In an embodiment, the support insert 92 is fastened to the female top frame 72 with a screw 94 and a spring washer 96. FIG. 15B depicts a nonlimiting example of a spring washer 96. FIG. 15C depicts a nonlimiting example of a screw 94. In an embodiment, the support insert 92 (and further, the male top frame 82) is detachably connected to the female top frame 72, such as via a screw connector. A “screw connector” includes a screw 94 and, optionally, a spring washer 96.

The top frame provides a horizontal tube (including the horizontal tube 76 of the female top frame 72 and the horizontal tube 86 of the male top frame 82) from which a user may hang items such as garments, linens, towels, and combinations thereof. Nonlimiting examples of garments include coats, sweaters, blouses, pants, dresses, skirts, and combinations thereof. Nonlimiting examples of linens include sheets, table cloths, blankets, napkins, and combinations thereof. The items may or may not be hung via a hanger.

The bottom vertical tube 52, the intermediate vertical tube 64, the female top frame 72, and the male top frame 82 are formed from a rigid material. A nonlimiting example of a suitable rigid material is a metal such as steel. The bottom vertical tube 52, the intermediate vertical tube 64, the female top frame 72, and the male top frame 82 may or may not be formed from the same type of rigid material. The bottom vertical tube 52, the intermediate vertical tube 64, the female top frame 72, and the male top frame 82 may or may not be coated. Nonlimiting examples of suitable coatings include paint, platings, and polymeric coatings. A nonlimiting example of a suitable plating is a chrome plating (forming a “chromed” material). In an embodiment, the bottom vertical tube 52, the intermediate vertical tube 64, the female top frame 72, and the male top frame 82 each is formed from a chromed steel.

In an embodiment, the vertical tube 74 of the female top frame 72 and the vertical tube 84 of the male top frame 82 include a vertical post end cap 98, as shown in FIG. 15A. The vertical post end cap 98 is sized to fit within a portion of the vertical tube 74 or the vertical tube 84. Vertical post end caps 98 are advantageous because they cover sharp edges, making the garment rack 10 safer for a consumer to use. The vertical post end cap 98 is formed from a rigid material. A nonlimiting example of a suitable rigid material is a polymeric material. FIG. 15D depicts a front perspective view and a rear perspective view of a nonlimiting example of a vertical post end cap 98 formed from a polymeric material.

### F. Garment Rack

In an embodiment, the garment rack 10 includes a bottom frame having a “Z-shape” 14 detachably connected to two bottom vertical tubes 52. Each bottom vertical tube 52 is detachably connected to an intermediate vertical tube 64 (a first intermediate vertical tube and a second intermediate vertical tube). The first intermediate vertical tube 64 is detachably connected to a female top frame 72. The second intermediate vertical tube 64 is detachably connected to a male top frame 82. The female top frame 72 is detachably connected to the male top frame 82. In an embodiment, a plurality of wheels 38 are detachably connected to the bottom frame having a “Z-shape” 14.

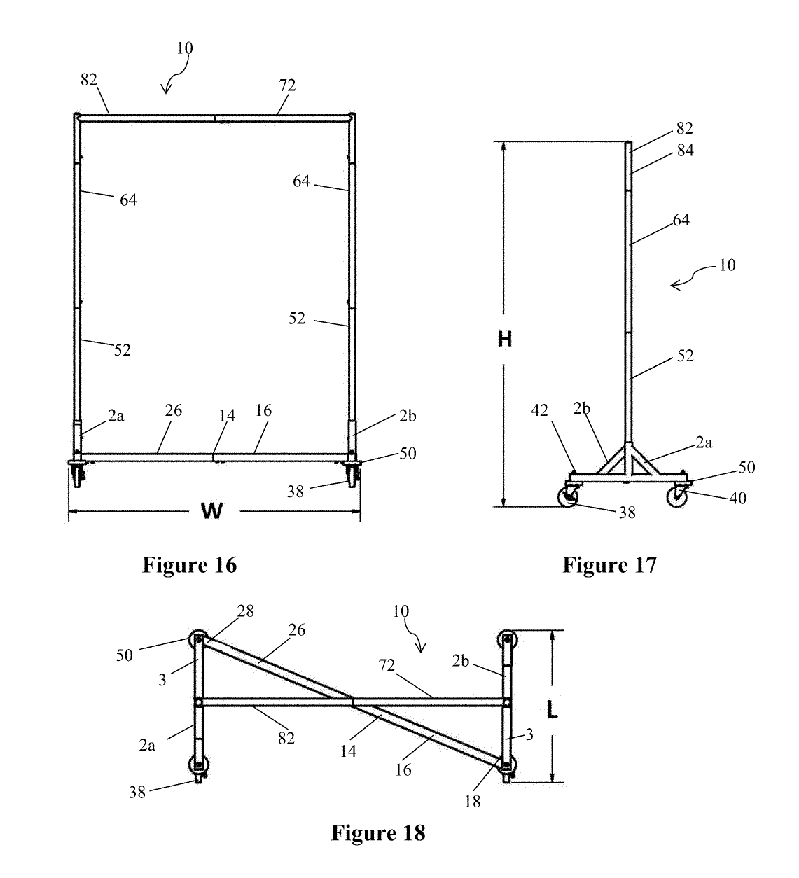

The garment rack 10 has a width, W, as shown in FIG. 16. In an embodiment, the garment rack 10 has a width, W, from 40 inches (in.), or 45 in., or 50 in., or 55 in. to 60 in., or 65 in., or 70 in., or 75 in., or 80 in. In another embodiment, the garment rack 10 has a width, W, of 58.5 in.

The garment rack 10 has a height, H, as shown in FIG. 17. In an embodiment, the garment rack 10 has a height, H, from 60 in., or 65 in., or 70 in. to 75 in., or 80 in., or 85 in., or 90 in. In another embodiment, the garment rack 10 has a height, H, of 75 in.

The garment rack 10 has a length, L, as shown in FIG. 18. In an embodiment, the garment rack 10 has a length, L, from 20 in., or 25 in. to 30 in., or 35 in., or 40 in. In another embodiment, the garment rack 10 has a length, L, of 27.3 in.

In an embodiment, the garment rack 10 has a width, W, of 58.5 in., a height, H, of 75 in., and a length, L, of 27.3 in.

In an embodiment, the garment rack 10 has a weight of from 15 pounds (lbs.), or 20 lbs., or 25 lbs. to 30 lbs., or 35 lbs., or 40 lbs. In an embodiment, the garment rack 10 has a weight from 25 lbs., or 26 lbs. to 27 lbs., or 28 lbs., or 29 lbs.

The present garment rack 10 with three detachable vertical components (the bottom vertical tube 52, the intermediate vertical tube 64, and the vertical tube 74, 84 of the top frame) is easy to transport by having a compact packaging size. Further, the present garment rack 10 is simple for a user to assemble, and disassemble, after purchase.

### G. Kit

The present disclosure also provides a kit for a garment rack. The kit includes:

a first bottom side frame comprising a male connector and a vertical tube connector;

a second bottom side frame comprising a male connector and a vertical tube connector;

a male bottom diagonal frame comprising (i) a first end comprising a support insert and (ii) a second end comprising a female connector sized to receive the male connector of the second bottom side frame;

a female bottom diagonal frame comprising (i) a first end comprising a female connector sized to receive the support insert of the male bottom diagonal frame and (ii) a second end comprising a female connector sized to receive the male connector of the first bottom side frame;

a first bottom vertical tube comprising (i) a first end sized to be received by the vertical tube connector of the first bottom side frame and (ii) a second end comprising a male connector;

a second bottom vertical tube comprising (i) a first end sized to be received by the vertical tube connector of the second bottom side frame and (ii) a second end comprising a male connector;

a first intermediate vertical tube comprising (i) a first end comprising a female connector sized to receive the male connector of the first bottom vertical tube and (ii) a second end comprising a male connector;

a second intermediate vertical tube comprising (i) a first end comprising a female connector sized to receive the male connector of the second bottom vertical tube and (ii) a second end comprising a male connector;

a male top frame comprising (i) a first end comprising a female connector sized to receive the male connector of the second intermediate vertical tube and (ii) a second end comprising a support insert; and

a female top frame comprising (i) a first end comprising a female connector sized to receive the male connector of the first intermediate vertical tube and (ii) a second end comprising a female connector sized to receive the support insert of the male top frame.

In an embodiment, the components included in the kit are those components depicted in FIG. 2. FIG. 2 depicts an exploded perspective view of a garment rack 10 including:

a first bottom side frame 2a comprising a male connector 4 and a vertical tube connector 6;

a second bottom side frame 2b comprising a male connector 4 and a vertical tube connector 6;

a male bottom diagonal frame 26 comprising (i) a first end 30 comprising a support insert 34 and (ii) a second end 28 comprising a female connector sized to receive the male connector 4 of the second bottom side frame 2b;

a female bottom diagonal frame 16 comprising (i) a first end 20 comprising a female connector sized to receive the support insert 34 of the male bottom diagonal frame 26 and (ii) a second end 28 comprising a female connector sized to receive the male connector 4 of the first bottom side frame 2a;

a first bottom vertical tube 52 comprising (i) a first end 53 sized to be received by the vertical tube connector 6 of the first bottom side frame 2a and (ii) a second end comprising a male connector 54;

a second bottom vertical tube 52 comprising (i) a first end 53 sized to be received by the vertical tube connector 6 of the second bottom side frame 2b and (ii) a second end comprising a male connector 54;

a first intermediate vertical tube 64 comprising (i) a first end comprising a female connector 70 sized to receive the male connector 54 of the first bottom vertical tube 52 and (ii) a second end comprising a male connector 66;

a second intermediate vertical tube 64 comprising (i) a first end comprising a female connector 70 sized to receive the male connector 54 of the second bottom vertical tube 52 and (ii) a second end comprising a male connector 66;

a male top frame 82 comprising (i) a first end comprising a female connector 85 sized to receive the male connector 66 of the second intermediate vertical tube 64 and (ii) a second end comprising a support insert 92; and

a female top frame 72 comprising (i) a first end comprising a female connector 75 sized to receive the male connector 66 of the first intermediate vertical tube 64 and (ii) a second end comprising a female connector 77 sized to receive the support insert 92 of the male top frame 82.

In an embodiment, the kit includes a plurality of wheels 38, a plurality of wheel brackets 40, and a plurality of wheel bumpers 50. In an embodiment, the kit includes an equal number of wheels 38, wheel brackets 40, and wheel bumpers 50. In an embodiment, the kit four wheels 38, four wheel brackets 40, and four wheel bumpers 50. In an embodiment, the kit includes at least one, or at least two wheel bracket locks 44. In an embodiment, the kit includes from 1 to 2, or 3, or 4 wheel bracket locks 44. In another embodiment, the kit includes a plurality of hex-nuts 46 and a plurality of wheel spring washers 48. In an embodiment, the kit includes four hex-nuts 46 and four wheel spring washers 48.

In an embodiment, the kit includes a plurality of screws 94 and a plurality of spring washers 96. In another embodiment, the kit includes a plurality of push-pin connectors including a plurality of push-pins 60 and a plurality of push-pin springs 62.

In an embodiment, the kit includes a plurality of bottom side frame end caps 8. In an embodiment, the kit includes four bottom side frame end caps 8. In another embodiment, the kit includes a plurality of vertical post end caps 98. In an embodiment, the kit includes two vertical post end caps 98.

In an embodiment, the kit includes a tool, or a plurality of tools to assist a user in assembling the garment rack. Nonlimiting examples of suitable tools include a screw driver, a wrench, and combinations thereof.

In an embodiment, the kit is contained in a package. Nonlimiting examples of suitable packages include boxes such as cardboard boxes. The package allows for easy transport of the kit.

The present kit advantageously has a compact packaging size. Further, the present kit is simple for a user to assemble into a garment rack after purchase.

### Definitions

The term “detachably connected” refers to two components reversibly connected, or reversibly fastened, to each other. Nonlimiting examples of detachable connections, or detachable fastenings, include push-pin connectors and screw connectors.

Additionally, “connections” or “ends” are understood to be interchangeable. That is, male/female ends or connections can be female/male ends or connections. Push-pin connections can be simple male-female friction or gravity-based connections.

The term “parallel,” as used herein, indicates two components extend in the same direction and never intersect.

A “threaded opening” is a void in a wall sized to receive a threaded connector, such as a screw. The threaded opening allows the threaded connector to extend through the wall.

A “push-pin opening” is a void in a wall sized to receive a push-pin. The push-pin opening allows the push-pin to extend through the wall.

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A garment rack comprising:
a bottom frame having a Z-shape;
a first bottom vertical tube having a first end and a second end, the first end detachably connected to the bottom frame and the second end detachably connected to a first or female top frame;
a second bottom vertical tube having a first end and a second end, the first end detachably connected to the bottom frame and the second end detachably connected to a second or male top frame;
a first or female top frame detachably connected the first bottom vertical tube; and
a second or male top frame detachably connected to the second bottom vertical tube;
the male top frame detachably connected to the female top frame.

2. The garment rack of claim 1, wherein:
the first bottom vertical tube is detachably connected to the bottom frame and the top frame by at least one intermediate vertical tube; and
the second bottom vertical tube is detachably connected to the bottom frame and the top frame by the same amount of vertical tube(s).

3. The garment rack of claim 1, wherein:
the first bottom vertical tube is detachably connected to the bottom frame and the top frame by a first intermediate vertical tube; and
the second bottom vertical tube is detachably connected to the bottom frame and the top frame a second intermediate vertical tube.

4. The garment rack of claim 3, wherein the Z-shape is defined by a first angle of the in the bottom frame having about a 20° to about a 170° angle, and a second angle of the bottom frame having about a 20° angle to about a 170° angle.

5. The garment rack of claim 1, wherein the first end of the first bottom vertical tube is detachably connected to the bottom frame via a push-pin connector.

6. The garment rack of claim 1, wherein the first end of the first bottom vertical tube is detachably connected to the bottom frame via a male/female connection.

7. The garment rack of claim 1, wherein the first end of the second bottom vertical tube is detachably connected to the bottom frame via a push-pin connector.

8. The garment rack of claim 1, wherein the first end of the second bottom vertical tube is detachably connected to the bottom frame via a male/female connection.

9. The garment rack of claim 3, wherein the second end of the first bottom vertical tube is detachably connected to the first intermediate vertical tube via a push-pin connector.

10. The garment rack of claim 4, wherein the second end of the second bottom vertical tube is detachably connected to the second intermediate vertical tube via a male/female connection.

11. The garment rack of claim 1, wherein the bottom frame comprises:
a first bottom side frame;
a second bottom side frame;
a first or female bottom diagonal frame detachably connected to the first bottom side frame; and
a second or male bottom diagonal frame detachably connected to the second bottom side frame;
wherein the first or female bottom diagonal frame and the second or male bottom diagonal frame are detachably connected to each other.

12. The garment rack of claim 1, wherein:
the first or female top frame comprises a top frame vertical tube connected to first bottom vertical tube and a horizontal tube; and
the second or male top frame comprises a top frame vertical tube connected to the second bottom vertical tube and a horizontal tube; wherein
the two horizontal tubes are engaged to form the top frame.

13. The garment rack of claim 1 further comprising a plurality of wheels connected to the bottom frame.

14. The garment rack of claim 12 further comprising a plurality of wheel bumpers.

15. The garment rack of claim 13 wherein each wheel of the plurality of wheels is connected to the bottom frame via a wheel bracket.

16. The garment rack of claim 14 wherein at least two wheel brackets have a lock.

17. A kit for a garment rack comprising:
a first bottom side frame comprising a bottom frame connector and a vertical tube connector;
a second bottom side frame comprising a bottom frame connector and a vertical tube connector;
a diagonal bottom frame comprising (i) a first end comprising a connector and (ii) a second end comprising joining connector
the bottom side frames and diagonal bottom frame forming a Z-shape when engaged;
a first vertical tube comprising (i) a first end comprising a connector sized to receive the connector of the first bottom side frame tube and (ii) a second end comprising a connector;
a second vertical tube comprising (i) a first end comprising a connector sized to receive the second bottom side frame and (ii) a second end comprising a male connector;
a first top frame comprising (i) a first end comprising a connector sized to receive a corresponding connector of the first vertical tube and (ii) a second end comprising a support insert; and
a second top frame comprising (i) a first end comprising a connector sized to receive the second connector of the second vertical tube and (ii) a second end comprising a connector;
wherein the second end connectors of the top frames are sized to join.

18. The kit of claim 17, further comprising:
a first intermediate vertical tube sized to join the first bottom side frame and the first vertical tube; and
a second intermediate vertical tube sized to join the second bottom side frame and the second vertical tube.

19. The kit of claim 17, wherein at least one of the connectors are push-pin connectors.

20. The kit of claim 17, further comprising:
a plurality of wheels;
a plurality of wheel brackets; and
a plurality of wheel bumpers.

21. The kit of claim 17, further comprising:
a plurality of screws; and
a plurality of spring washers.

22. The kit of claim 17, further comprising:
a plurality of push-pins;
a plurality of push-pin springs.

23. The kit of claim 17, further comprising:
a plurality of bottom side frame end caps; and
a plurality of vertical post end caps.

24. A kit for a garment rack comprising:
a first bottom side frame comprising a bottom frame or male connector and a vertical tube connector;
a second bottom side frame comprising a bottom frame or male connector and a vertical tube connector;
a male bottom diagonal frame comprising (i) a first end comprising a support insert and (ii) a second end comprising a female connector sized to receive the male connector of the second bottom side frame;
a female bottom diagonal frame comprising (i) a first end comprising a female connector sized to receive the support insert of the male bottom diagonal frame and (ii) a second end comprising a female connector sized to receive the male connector of the first bottom side frame;
a first bottom vertical tube comprising (i) a first end sized to be received by the vertical tube connector of the first bottom side frame and (ii) a second end comprising a male connector;
a second bottom vertical tube comprising (i) a first end sized to be received by the vertical tube connector of the second bottom side frame and (ii) a second end comprising a male connector;
a first intermediate vertical tube comprising (i) a first end comprising a female connector sized to receive the male connector of the first bottom vertical tube and (ii) a second end comprising a male connector;
a second intermediate vertical tube comprising (i) a first end comprising a female connector sized to receive the male connector of the second bottom vertical tube and (ii) a second end comprising a male connector;
a male top frame comprising (i) a first end comprising a female connector sized to receive the male connector of the second intermediate vertical tube and (ii) a second end comprising a support insert; and
a female top frame comprising (i) a first end comprising a female connector sized to receive the male connector of the first intermediate vertical tube and (ii) a second end comprising a female connector sized to receive the support insert of the male top frame.
